(19) United States
(12) Patent Application Publication
(10) Pub. No.: US 2012/0097115 A1
(43) Pub. Date: Apr. 26, 2012

(54) PET CHEW TOY

(76) Inventor: YI CHIH LIN, Chiayi County (TW)

(21) Appl. No.: 12/910,154

(22) Filed: Oct. 22, 2010

(51) Int. Cl. A01K 29/00

(52) U.S. Cl. 119/710

(57) ABSTRACT

A pet chew toy contains contain a plurality of bite resistant cowskins and a meat sauce material, all of which are mixed together, wherein the cowskins are ground into grains respectively, and the meat sauce material is selected from at least one of chicken, duck, goose, pork, beef, and mutton and then is ground into a meat sauce, then the meat sauce material and the grained cowskins are mixed together and press formed by an extruder machine to be further dried and cut into various shapes, thus finishing the pet chew toy.

### BACKGROUND OF THE INVENTION

1. Field of the Invention

The present invention relates to a pet chew toy, and more particularly to a pet chew toy that contains bite resistant and grained cowskins so that the pet is capable of cleaning its mouth cavity during a biting process.

2. Description of the Prior Art

A conventional pet chew toy to clean a pet's mouth cavity is formed in a bone shape and includes a rod-shaped and bite resistant body, and a middle section of the body is covered by a sauce layer but two ends thereof expose outward. However, after a dog bites the sauce layer of the pet chew toy for a period of time, the sauce layer is eaten completely to remain the body without any flavor, then the dog will lose its appetite to bite the pet chew toy, hence a cleaning purpose to dog's month cavity will lose.

Another pet chew toy to clean a pet's mouth cavity is formed in a bar shape and made of meat sauce, but the meat sauce can not be used to clean mouth cavity. Moreover, another improved conventional pet chew toy includes an inner body covered by an outer body, and the outer body includes two connecting projections disposed on two ends thereof respectively. In a first gap of the inner body and a second gap between the inner and the outer bodies are formed a sauce layer so that when the dog bites the pet chew toy, it can also eat the sauce layer to keep appetite and clean teeth.

Nevertheless, the inner and the outer bodies of such an improved pet chew toy have to be molded, and then at least one hole is disposed on the inner and the outer bodies to feed a meat sauce into the first and the second gaps. But it is not sure whether the meat sauce is full of the first and the second gaps completely, and the meat sauce is easy to leak during a feeding and a drying processes. Also, the inner and the outer bodies are made of a cowskin piece that can not be digested by the dog easily.

The present invention has arisen to mitigate and/or obviate the afore-described disadvantages.

### SUMMARY OF THE INVENTION

The primary object of the present invention is to provide a pet chew toy that when the pet swallows the bite resistant and grained cowskins, due to the cowskins are formed in a grain shape, they are easy to be digested to prevent from indigestion.

Further object of the present invention is to provide a pet chew toy that contains bite resistant and grained cowskins so that the pet is capable of cleaning its mouth cavity during a biting process.

Another object of the present invention is to provide a pet chew toy that a meat small is prolonged to enhance the pet's appetite to bite the pet chew toy.

To obtain the above objectives, a pet chew toy provided by the present invention contains:

a plurality of bite resistant cowskins and a meat sauce material, all of which are mixed together, wherein the cowskins are ground into grains respectively, and the meat sauce material is selected from at least one of chicken, duck, goose, pork, beef, and mutton and then is ground into a meat sauce, then the meat sauce material and the grained cowskins are mixed together and press formed by an extruder machine to be further dried and cut into various shapes, thus finishing the pet chew toy.

### BRIEF DESCRIPTION OF THE DRAWINGS

FIG. 1 is a perspective view showing the assembly of a pet chew toy according to a first embodiment of the present invention;

FIG. 2 is a perspective view showing the assembly of a pet chew toy according to a second embodiment of the present invention;

FIG. 3 is a perspective view showing the assembly of a pet chew toy according to a third embodiment of the present invention;

FIG. 4 is a cross sectional view showing the assembly of the pet chew toy according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

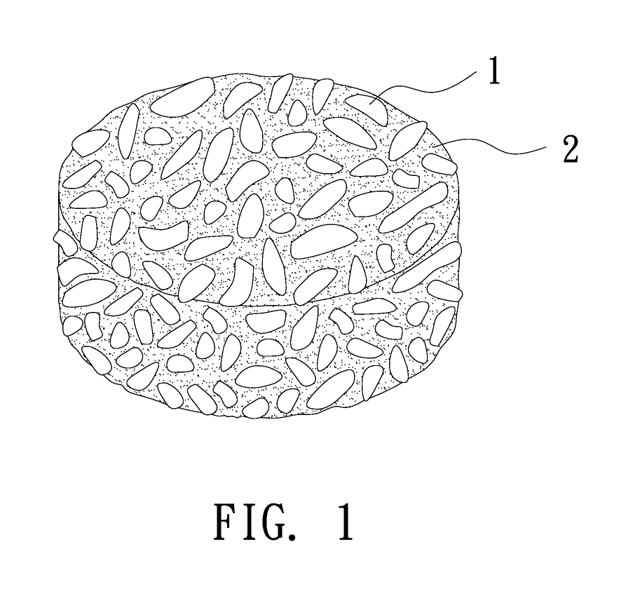

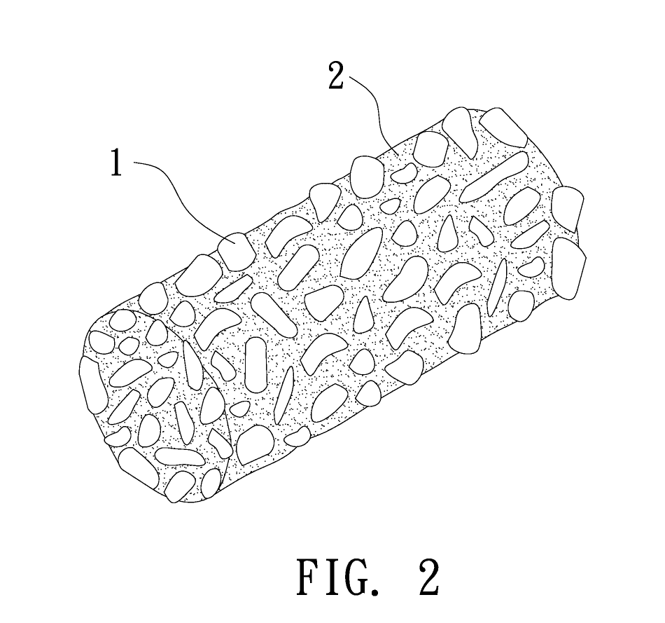

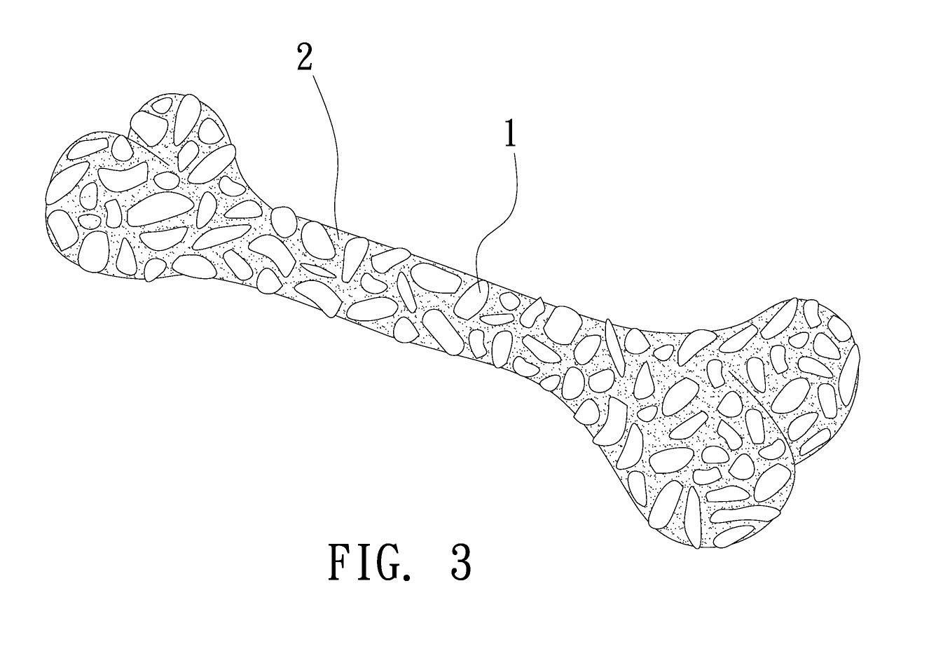

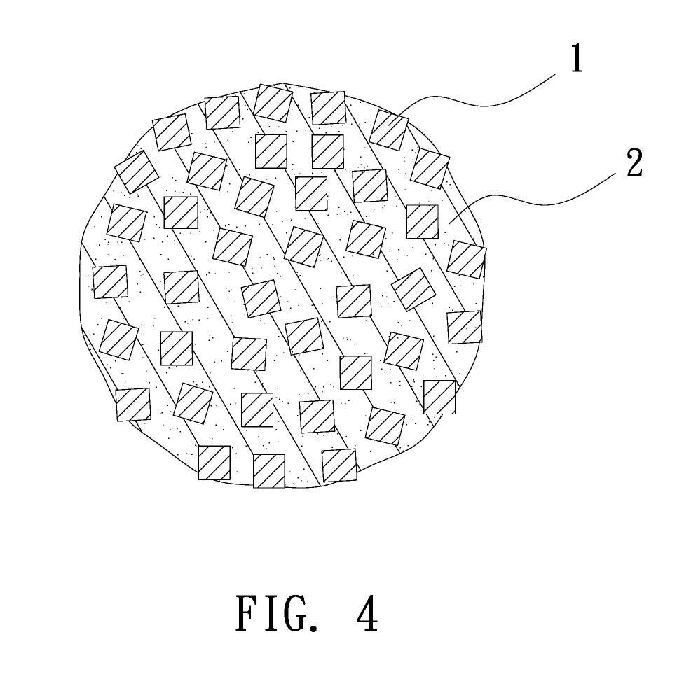

With reference to FIGS. 1-4, a pet chew toy according to the present invention comprises a plurality of bite resistant cowskins 1 and a meat sauce material 2, all of which are mixed together, wherein the cowskins 1 are ground into grains respectively, and the meat sauce material 2 is selected from at least one of chicken, duck, goose, pork, beef, and mutton and then is ground into a meat sauce, then the meat sauce material 2 and the grained cowskins 1 are mixed together and press formed by an extruder machine to be further dried and cut into various shapes, thus finishing the pet chew toy.

When the pet chew toy of the present invention is bitten by a pet, because the pet chew toy is comprised of the grained cowskins and the meat sauce material, all of which are mixed together, press formed, dried, and cut into a lump or piece, the pet chew toy contains bite resistant and grained cowskins so that the pet is capable of cleaning its mouth cavity during a biting process. In addition, when the pet swallows the bite resistant and grained cowskins, due to the cowskins are formed in a grain shape, they are easy to be digested to prevent from indigestion. Furthermore, the pet chew toy is press formed from the mixed meat sauce material and the cowskins, a meat small is prolonged to enhance the pet's appetite to bite the pet chew toy.

While we have shown and described various embodiments in accordance with the present invention, it is clear to those skilled in the art that further embodiments may be made without departing from the scope of the present invention.

What is claimed is:

1. A pet chew toy comprising:
a plurality of bite resistant cowskins and a meat sauce material, all of which are mixed together, characterized in that the cowskins are ground into grains respectively.

2. The pet chew toy as claimed in claim 1, wherein the meat sauce material is selected from at least one of chicken, duck, goose, pork, beef, and mutton and then is ground into a meat sauce.
